(19) United States
(12) Patent Application Publication
(10) Pub. No.: US 2018/0201336 A1
(43) Pub. Date: Jul. 19, 2018

(54) MODULAR TRAILER AND MANUFACTURING METHOD

(71) Applicant: Universal Trailer Cargo Group, Inc., Fort Myers, FL (US)

(72) Inventors: Joe Mckeever, Lakeville, IN (US); James Springsteen, Nile, MI (US); Ian Dill, Mishawaka, IN (US)

(21) Appl. No.: 15/868,254

(22) Filed: Jan. 11, 2018

Related U.S. Application Data
(60) Provisional application No. 62/445,975, filed on Jan. 13, 2017.

(51) Int. Cl. B62D 63/06; B62D 65/02; B62D 29/00; B62D 27/06

(52) U.S. Cl. CPC B62D 63/061; B62D 27/06; B62D 29/007; B62D 65/02

(57) ABSTRACT

A modular trailer may include a floor component, two side wall components, a front wall component, a rear wall component, a rear door component, and a roof component. At least some of the components may be interchangeable, such that they are attached to one another via fasteners that allow any one of the interchangeable components to be removed from the modular trailer without disassembling the modular trailer. A method of manufacturing the modular trailer may include assembling the components but not completely assembling the trailer, so that the trailer can be shipped in a more efficient, cost effective, unassembled form.

### RELATED APPLICATION(S)

This patent application claims the benefit of U.S. Patent Application Ser. No. 62/445,975 filed on Jan. 13, 2017, the entirety of which is hereby incorporated by reference.

### TECHNICAL FIELD

This invention relates to the field of cargo trailers and more particularly to modular, collapsible cargo trailers and trailer kits and methods of manufacturing such trailers.

### BACKGROUND

Building and transporting cargo trailers to distributors and other customers is typically quite inefficient. Cargo trailers are normally fully assembled by the manufacturer and then shipped to the distribution site. Raw steel structural parts are purchased in an open market method. This creates a “supply chain” environment, with the use of the same steel structural parts, purchased from “tier 1” suppliers, with no real innovation for steel shapes, and the necessity of staffing accordingly to convert raw steel lengths to the appropriate usable configurations and manually weld the chassis, creating a rigid “box of air.” The assembled box of air must then be shipped to the customer, which adds shipping expenses that create a cost barrier of approximately 850 miles around each original equipment manufacturer (OEM) manufacturing site. Since even small trailers are relatively cumbersome to ship, as well as to display, the cost of shipping becomes a substantial expense. Additionally, the space necessary to display and inventory these trailers creates additional expense.

### BRIEF SUMMARY

The present disclosure describes a modular, “knock-down” trailer kit or collapsible trailer kit and a method for manufacturing the trailer. The trailer can be easily assembled in a different location from the original kit welding method, and it can be manufactured at a first location and assembled and/or completed at a second location, thus reducing shipping and/or storage expenses.

In one aspect of the present disclosure, a modular trailer (or “trailer kit”) may include: a floor component; two side wall components; a front wall component; a rear wall component; a rear door component; and a roof component. At least some of the components are interchangeable, such that they are attached to one another via fasteners that allow any one of the interchangeable components to be removed from the modular trailer without disassembling the modular trailer. In some embodiments, the components may be provided in an unassembled kit to be assembled by a user.

In some embodiments, each of the components may include two main rails and multiple cross members coupled to and extending between the two main rails. The main rails of the floor component, in some embodiments, may be made of 50 HSLA steel, and all the other main rails and cross members may be made of 36 structural steel. In some embodiments, the cross members are robotically welded to the two main rails. In some embodiments, the roof component may be attached to the front wall component, the rear wall component, and the two side wall components via a keyed fastening mechanism. For example, the keyed fastening mechanism may include a J-rail on a top of each of the front wall component, the rear wall component and the two side wall component and a U-shaped fixture on the roof component that fits over the J-rail.

In some embodiments, the front wall component attaches to the side wall components via tab fasteners. In some embodiments, the rear wall component includes a flange surface with a turned edge. In some embodiments, the rear door component is attached to the rear wall component via one left-sided hinge and multiple right-sided hinges. The rear door component may be attached to the rear wall component via one right-sided hinge and multiple left-sided hinges. The rear door component may be a single-sided ramp door and may be changeable to a double, barn door configuration. Optionally, the trailer may also include at least one D-ring plate for attaching a tie-down ring to the trailer. Also optionally, the trailer may include at least one drop-down jack weldment attached to a corner post of the trailer via a mechanical fastener without welding.

In another aspect of the present disclosure, a method for manufacturing a modular trailer may involve assembling multiple components, including a floor component, two side wall components, a front wall component, a rear wall component, a rear door component, and a roof component. Assembling each component may involve connecting multiple cross members across two main rails. At least some of the components are interchangeable, such that they are attached to one another via fasteners that allow any one of the components to be removed from the modular trailer without disassembling the modular trailer.

In some embodiments, assembling each of the components involves placing ends of the cross members into open channels of the main rails and welding the cross members to the main rails to form joints. In some embodiments, at least the welding step is performed by a robot. Assembling the floor component may involve attaching at least some cross members of the floor component to axle brackets attached to two main rails of the floor component. Optionally, the method may further involve attaching a wall panel member of each component to a frame of each component. In some embodiments, the wall panel member for each component is no more than one inch thick. In some embodiments, the cross members may have a U-shape or a G-shape. Optionally, the method may further include removing one of the components from the modular trailer and replacing the removed component with a replacement component having at least one of a different size or a different shape, without disassembling the rest of the modular trailer.

In some embodiments, the roof component may include a self-locating U-shaped fixture that fits over corresponding J-shaped fixtures on the tops of the wall components. In some embodiments, the method may further involve shipping the modular trailer in an unassembled kit configuration to a user. Some embodiments may further involve attaching at least one D-ring plate to the trailer, for attaching a tie-down ring to the trailer. Some embodiments may further involve attaching a drop-down jack weldment to the trailer using mechanical fasteners, without welding, and inserting a drop-down jack into the drop-down jack weldment.

These and other aspects are described in further detail below, in reference to the attached drawing figures.

### BRIEF DESCRIPTION OF THE DRAWINGS

FIGS. 1A-1H are various views of a trailer frame, according to one embodiment, with the various views being front perspective (FIG. 1A), right side (FIG. 1B), left side (FIG. 1C), front (FIG. 1D), rear (FIG. 1E), top (FIG. 1F), bottom (FIG. 1G), and exploded (FIG. 1H); is a block diagram of a system for monitoring fluid changes in the body, according to one embodiment;

FIG. 2A is a front perspective view of a roof frame and left side frame of a trailer, illustrating a method for connecting the two, according to one embodiment;

FIG. 2B is a close-up perspective view of a portion of the roof frame and left side frame of FIG. 2A, also showing a front piece, illustrating mechanisms for connecting the various pieces together, according to one embodiment;

FIG. 2C is an exploded view of the portion of the roof frame and side frame of FIG. 2B, illustrating how the two pieces fit together, according to one embodiment;

FIG. 2D is a front cross-sectional view of a J-rail used in a trailer frame, according to one embodiment;

FIG. 2E is a front cross-sectional view of a G-post used in a trailer frame, according to one embodiment;

FIGS. 3A-3C are perspective, side and perspective views, respectively, of an interlocking rail-and-cross-beam mechanism for attaching to parts of a trailer to one another, according to one embodiment;

FIG. 4A is a perspective view of a partially assembled trailer, illustrating a method for attaching a rear door onto a rear frame of the trailer via hinges, according to one embodiment;

FIGS. 4B and 4C are close-up, perspective views of a hinge for attaching a trailer door, as in FIG. 4A, illustrated in disassembled and assembled configurations, respectively;

FIGS. 4D and 4E are front perspective and rear perspective views, respectively, of a partially assembled trailer, as in FIG. 4A, but with additional parts added, illustrating a method for attaching a rear door onto a rear frame of the trailer via hinges, according to one embodiment;

FIG. 4F is a close-up of the rear perspective view of FIG. 4E;

FIG. 5A is a perspective view of a portion of a floor and a right side of a trailer, illustrating an interlocking an axle bracket mechanism for attaching the floor to the side, according to one embodiment;

FIG. 5B is a perspective view of the axle bracket mechanism of FIG. 5A;

FIG. 5C is a perspective view of a partially assembled trailer, illustrating a partially assembled floor, to show connectivity of the cross beams with the main rail, according to one embodiment;

FIG. 6 is a perspective view of a trailer with several interchangeable, alternative trailer parts illustrated in exploded view, according to one embodiment;

FIG. 7A is multi-view illustration of a D-ring mounting plate for a trailer, according to one embodiment;

FIGS. 7B and 7C are perspective views of the D-ring mounting plate of FIG. 7A, mounted to cross members of a trailer, according to one embodiment;

FIG. 7D is a multi-view illustration of another embodiment of a D-ring mounting plate;

FIG. 7E is a multi-view illustration of a support member for attaching to the trailer and the D-ring mounting plate of FIG. 7D;

FIG. 7F is a perspective view of the D-ring mounting plate of FIG. 7D and the support member of FIG. 7E, attached to cross members of a trailer and coupled to each other, according to one embodiment; and

FIGS. 8A-8D are perspective, top and two side views, respectively, of a drop-down jack weldment for a trailer, according to one embodiment;

FIGS. 8E and 8F are perspective views of the drop-down jack weldment being inserted into a post of a trailer, according to one embodiment;

FIG. 8G is a perspective view of the drop-down jack weldment with a drop-down jack inserted therein; and

FIGS. 8H-8K are perspective, top and two side views, respectively, of a drop-down jack weldment for a trailer, with a plate with one curved corner, according to one embodiment.

### DETAILED DESCRIPTION

Certain details are set forth below to provide a sufficient understanding of certain embodiments of the present disclosure. However, some embodiments of the disclosure may be practiced without these particular details. Moreover, the particular embodiments of the present disclosure are provided by way of example and should not be used to limit the scope of this disclosure to those particular embodiments.

This disclosure describes a collapsible, modular or “knock-down” trailer kit, and a method of manufacturing a trailer and/or assembling a trailer kit. In some embodiments, the trailer kit is partially assembled (for example by robotic welding) by a manufacturer, shipped from the manufacturer in the partially-assembled or kit configuration, and then fully assembled at a second location. Generally, the trailer includes a frame made of multiple components—floor, sides, roof, etc.—and panels covering the frame. The components of the frame are attached to one another using universal or modular attachment devices, so that some or all of the components of the frame are interchangeable. For example, in some embodiments, multiple different sizes and shapes of a front frame component may be used interchangeably on the same trailer—e.g., any of a number of different front frame components may be selected by the manufacturer, depending on the desires of the end user. Other components may be interchangeable or “swappable” as well. This may also allow a distributor or other end user to swap out one or more components of a trailer for different components without buying a completely new trailer. The attachment devices are also designed to allow trailer kit to be robotically welded, which greatly reduces labor and overall manufacturing costs. In some embodiments, the manufacturer can produce the trailer frame components and ship them in a knock-down or kit format, thus saving significant shipping costs while reducing the amount of labor necessary to build the trailer.

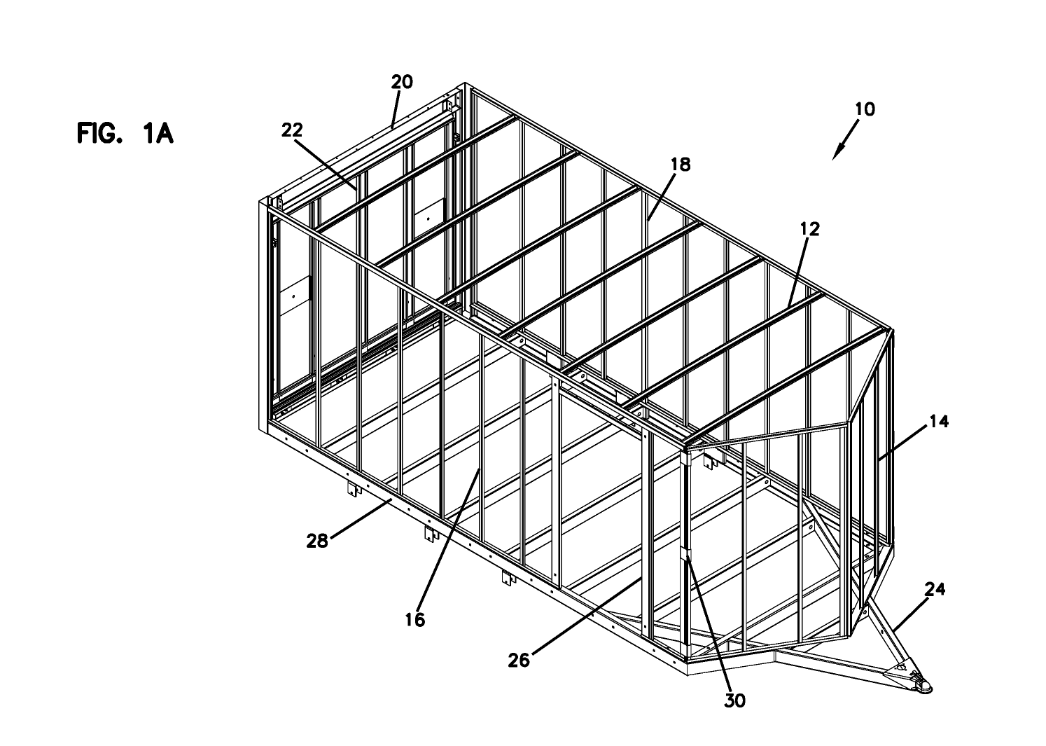

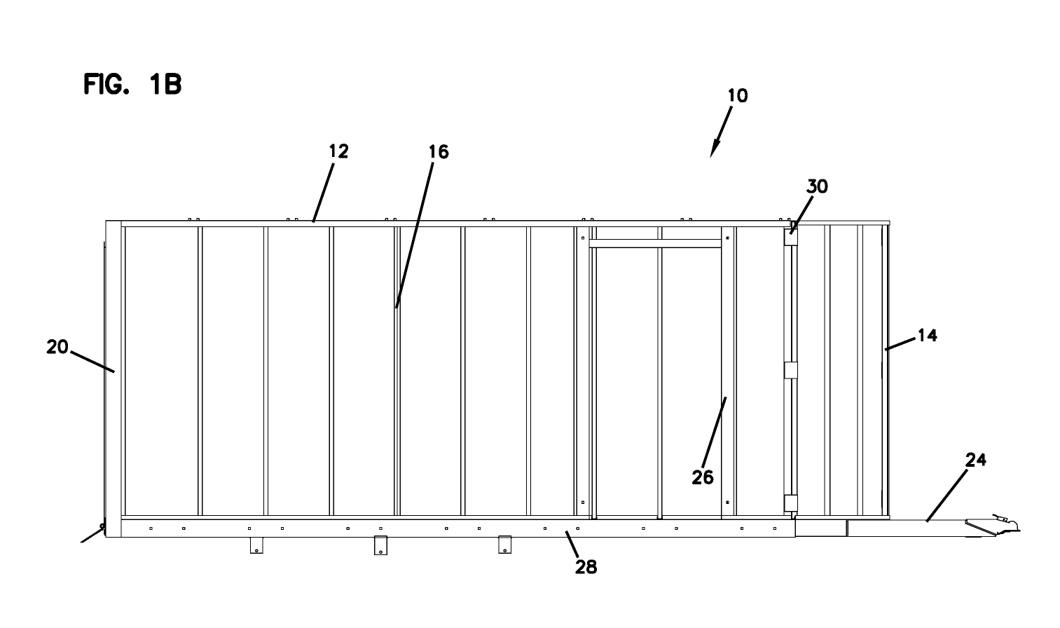

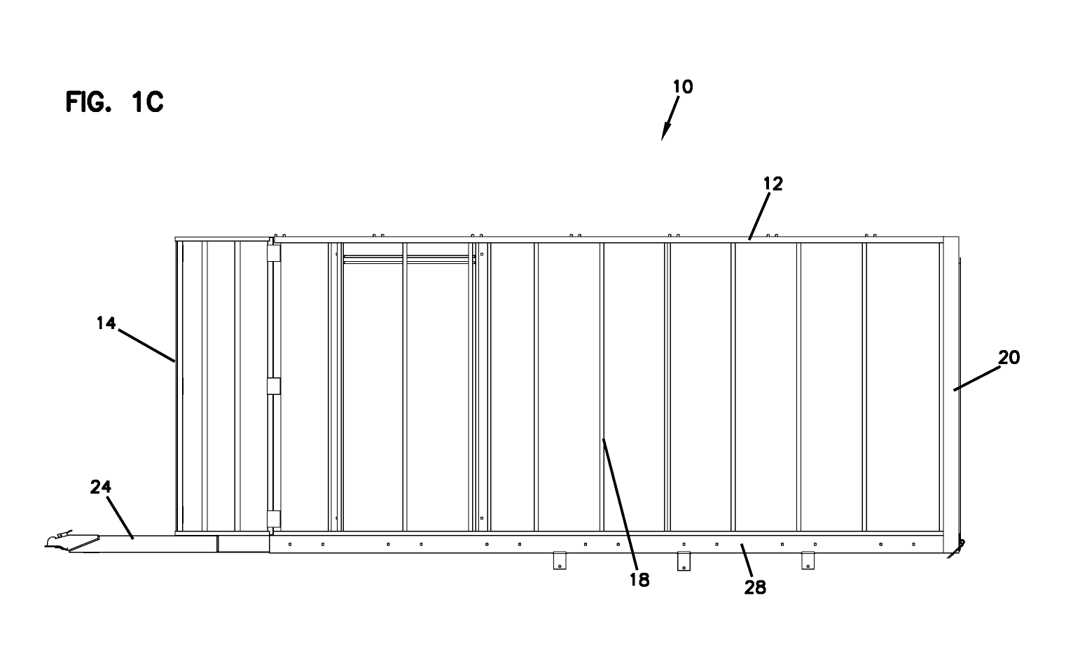

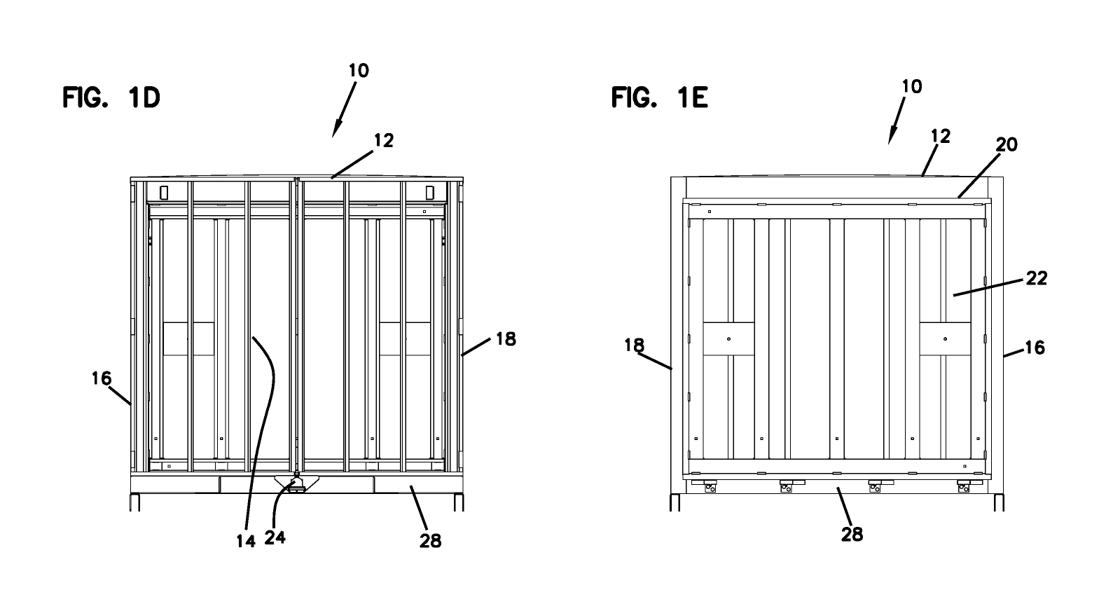

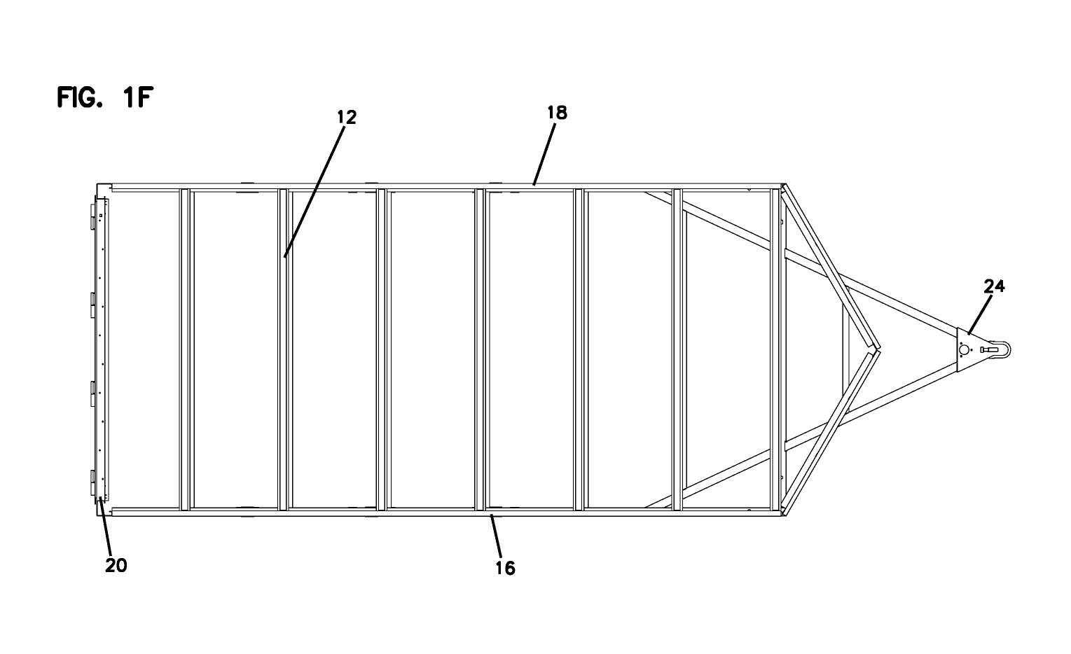

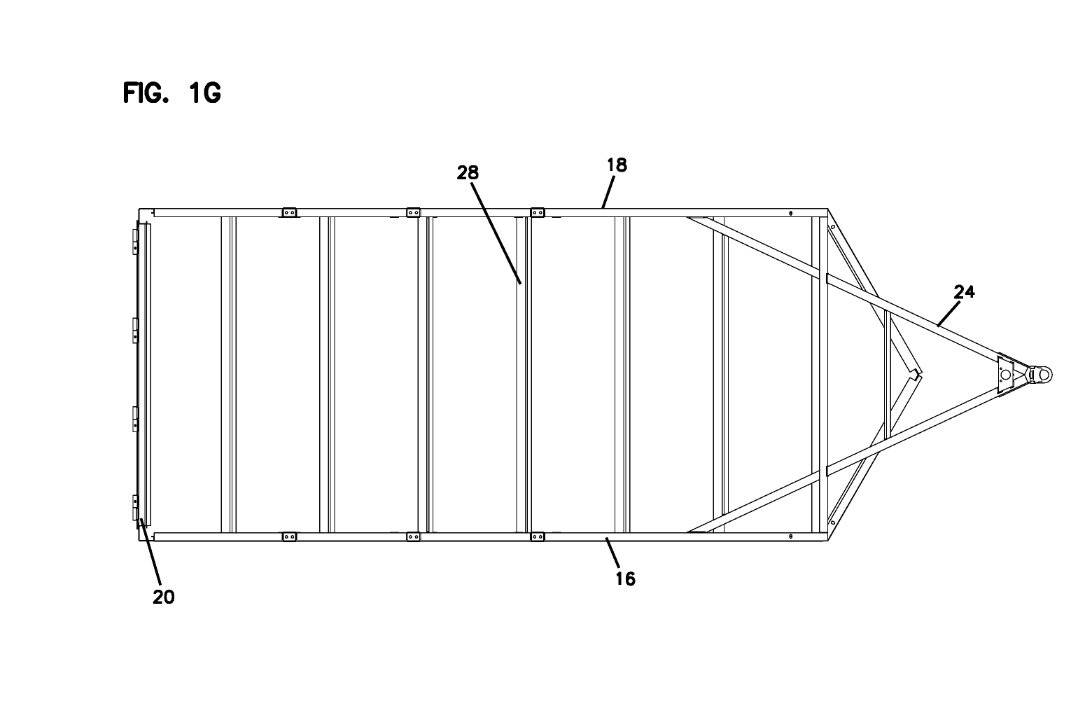

Referring now to FIG. 1A, one embodiment of a collapsible cargo trailer 10 is illustrated in perspective view. In FIG. 1A and many of the subsequent figures, trailer 10 is illustrated as a frame only, primarily for illustrative purposes. In any given embodiment, trailer 10 may be manufactured and sold as a frame only or as a complete trailer, include a frame and wall panels. Thus, although many of the figures in this application show only a frame, the disclosure is not limited to only the frame. Additionally, the term “trailer” is sometimes used interchangeably with “trailer kit,” so that these terms may have the same meaning herein.

Trailer 10 includes a number of main parts, which are known and referred to herein individually and collectively as “components” or “main components,” and which are also sometimes known and referred to as “subassemblies.” In this embodiment, the main components of trailer 10 include a floor 28 (or “chassis”), a right side wall 16 (or “curb side wall”), a left side wall 18 (or “road side wall”), a front wall 14, a rear wall 20 (or “rear hoop”), a rear closure 22 (or “ramp door”) and a roof 12. In this embodiment, trailer 10 also includes a side door frame 26 in right side wall 16, a trailer hitch piece 24, and multiple fasteners 30, which will be described in further detail below. In referring to right side wall 16 and left side wall 18, the perspective of right and left is drawn from the vantage of a driver of a car or truck pulling trailer 10, facing in the forward direction toward front wall 14 and away from rear wall 20.

In one embodiment of a method for manufacturing trailer 10, the main components are constructed in an easy to configure, robotically welded fixture. Efficiently converted steel posts (or “beams,” e.g., from coil), produced via a roll forming or other similar method (e.g., break form, turret press, etc.), come to the manufacturer preformed to the needed lengths for making the components, with tolerances of +/−0.015, for example, to support robotic welding requirements. The steel used to form the components of trailer 10 may be a high-strength, low-alloy steel, such as grade 50 HSLA for floor component 28, and grade 36 Structural Steel for all other components, in some embodiments. Using roll formed, high-strength, low-alloy steel facilitates robotic welding of the posts and other parts that make up the frame of trailer 10. The posts are precut to needed lengths, which also facilitates assembly. After the manufacturer receives the posts, they are robotically welded together to form each component. The welded components/subassemblies may then be washed and dipped in a paint primer vertically. After the paint drying process is complete, the components may be stacked/collated in specially designed configurations for shipping, and they may then be packed onto trailers/containers for transport to assembly operations. In some embodiments, trailer 10 may be shipped in a configuration as shown in FIG. 1A. In other embodiments, trailer 10 may be shipped in a collapsed or “stackable” configuration. Stackable trailer frames may allow for multiple frames to be stacked on one another for easier shipping.

Many different embodiments or “models” of trailer 10 may be available, and some or all of these embodiments may be interchangeable and adaptable, so that they might be expanded or otherwise altered to form other embodiments, some of which may be designed in the future. For example, floors 28 and walls 14, 16, 18, 20 may attach to one another in similar locations and using similar fasteners across embodiments, to allow for interchangeability of components across embodiments. In some embodiments, variations on roof 12 link to walls 14, 16, 18, 20 similarly, with a “key way” location method that self-locates the components and results in a square trailer 10 that can be assembled at an assembly plant without any additional welds required. Similarly, various embodiments of front wall 14 may attach to side walls 16, 18 in a similar, interchangeable fashion for multiple different types of front walls 14, using a mechanical fastening method with a tab (or flange, if required) on front wall 14 and a longer trailing flange on the first vertical wall structure. Rear wall/rear hoop 20 may have a flange surface (with a turned edge for strength), so that a mechanical fastener can be used to attach to the rear vertical wall structure.

In some embodiments, ramp door 22 may be attached to rear wall/rear hoop 20 via multiple right-sided hinges and one or more one-sided, left-sided hinges, which are bolted on to rear wall/rear hoop 20. In this embodiment, there may be several right handed hinges and a far left hinge that is a left-sided hinge, to prevent ramp door 22 from sliding out of its hinge engagement. This allows for in-field changes from a ramp door to a double “barn door,” rear enclosure. Such hinges are described in further detail below.

FIGS. 1B-1H show various view of trailer 10, as follows: FIG. 1B is a right side view; FIG. 1C is a left side view; FIG. 1D is a front view; FIG. 1E is a rear view; FIG. 1F is a top view; FIG. 1G is a bottom view; and FIG. 1H is a perspective, exploded view. As illustrated in FIG. 1H, in this embodiment, front wall 14 is made up of two parts, which come together, as shown in FIG. 1A, to form an angled front wall 14. In alternative embodiments, front wall 14 may be flat and/or one piece.

In various embodiments, trailer 10 may include any of a number of improved features. For example, in some embodiments, floor 28 is lighter, and walls 14, 16, 18, 20 are thinner than in conventional trailers. These lighter and/or thinner walls are made possible by the use of the materials described above and by the use of fasteners described below, all of which facilitates assembly by robotic welding. In one embodiment, for example, walls 14, 16, 18, 20 are approximately 1.0 inch thick, and the vertical wall posts (or beams) are made in two shapes. The first is a U-shape, and the second is G-shape. The G-shape has been found to have the same or similar rigidity as a conventional post, even while using one-third less steel. These post shapes are also described further below.

Roof 12 is configured, in some embodiments, to connect to walls 14, 16, 18, 20 via a drop-down method, allowing for a rigid and straight (self-locating) attachment method. This drop-down connection method is described in further detail below.

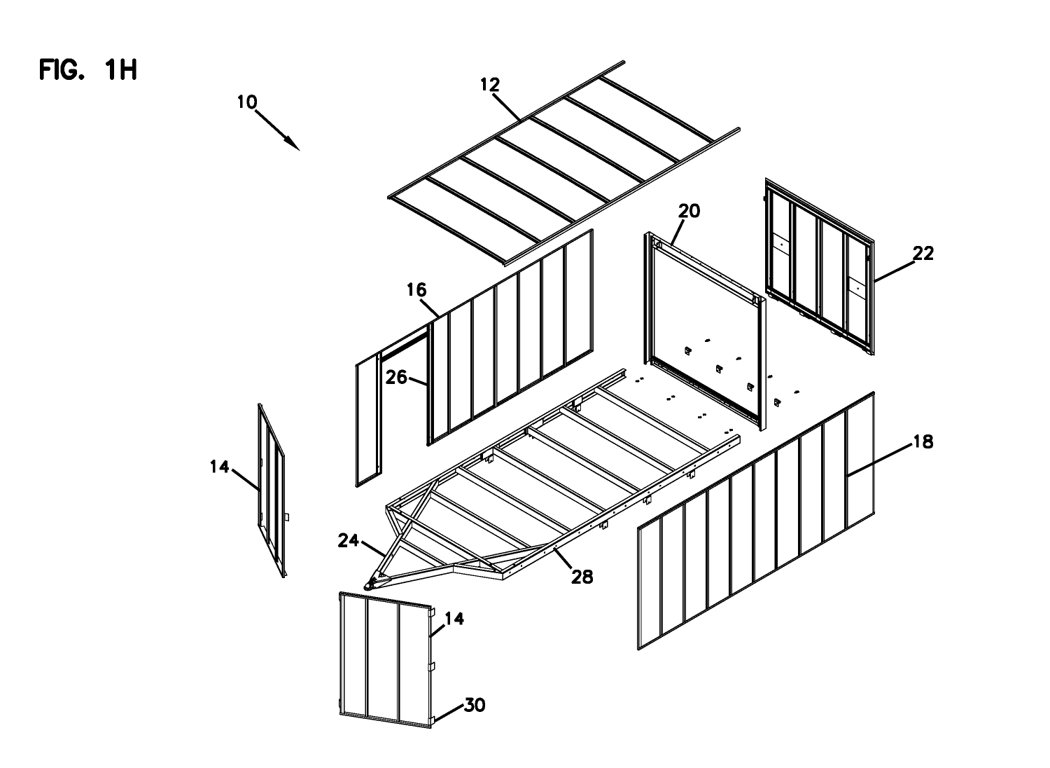

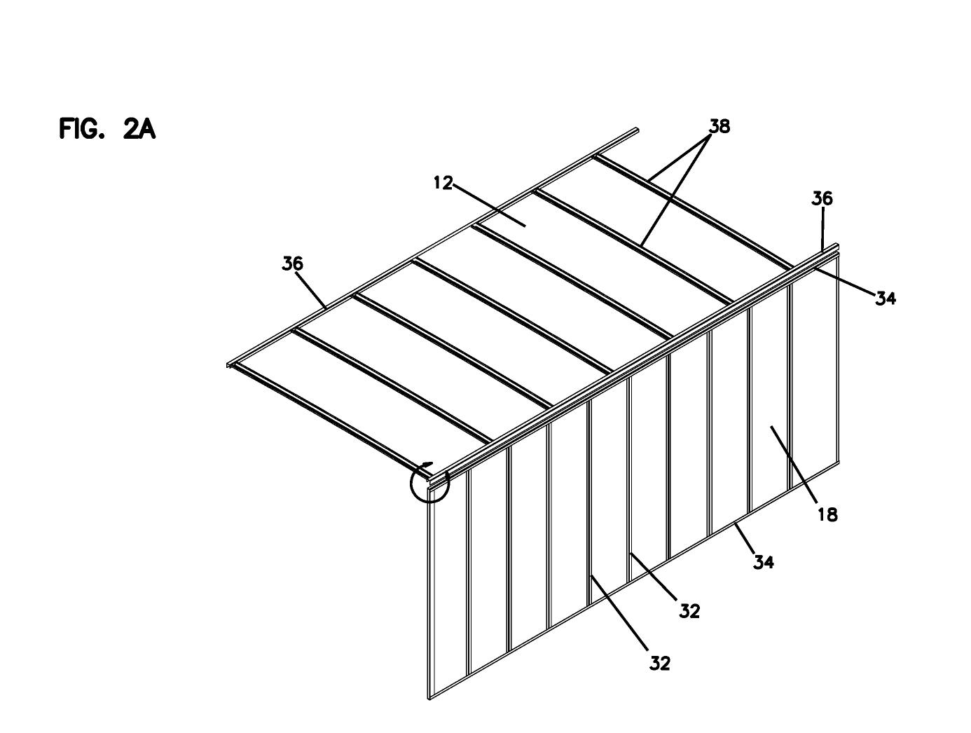

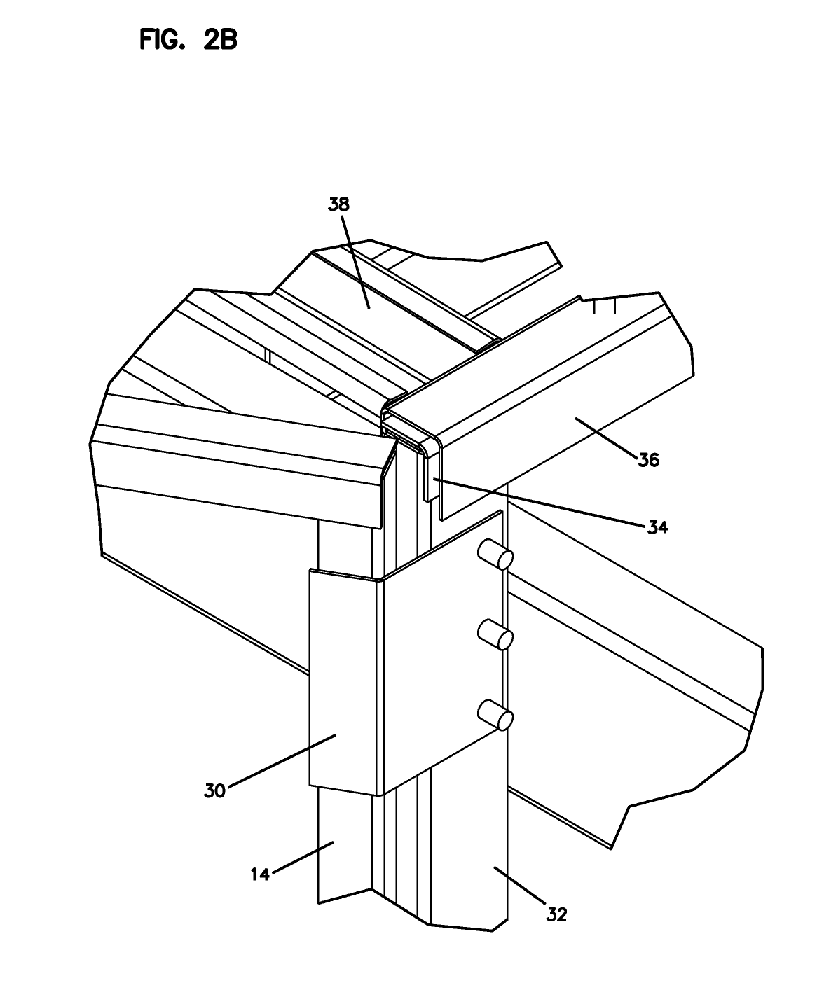

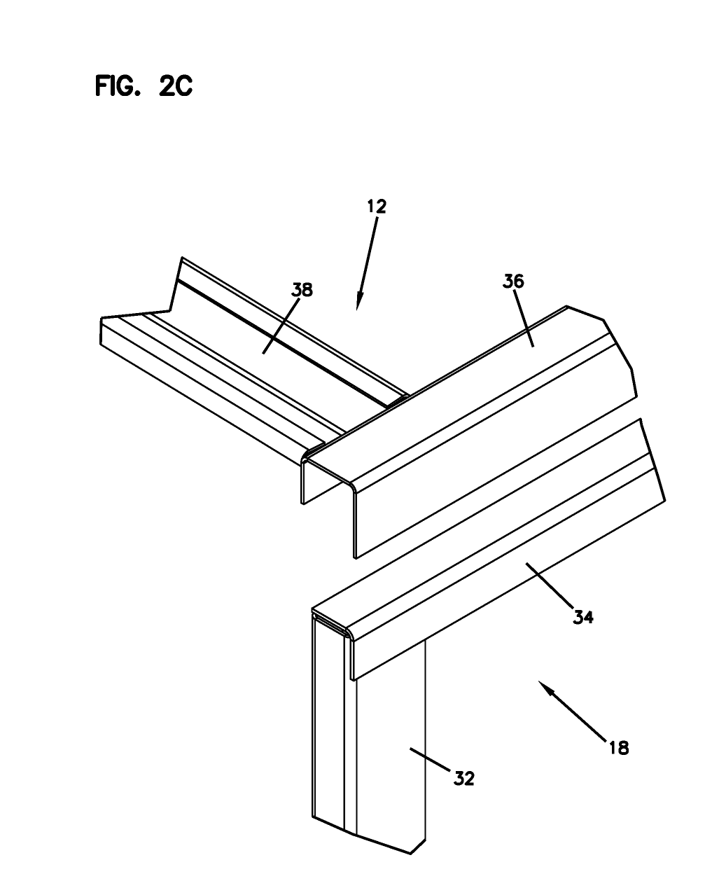

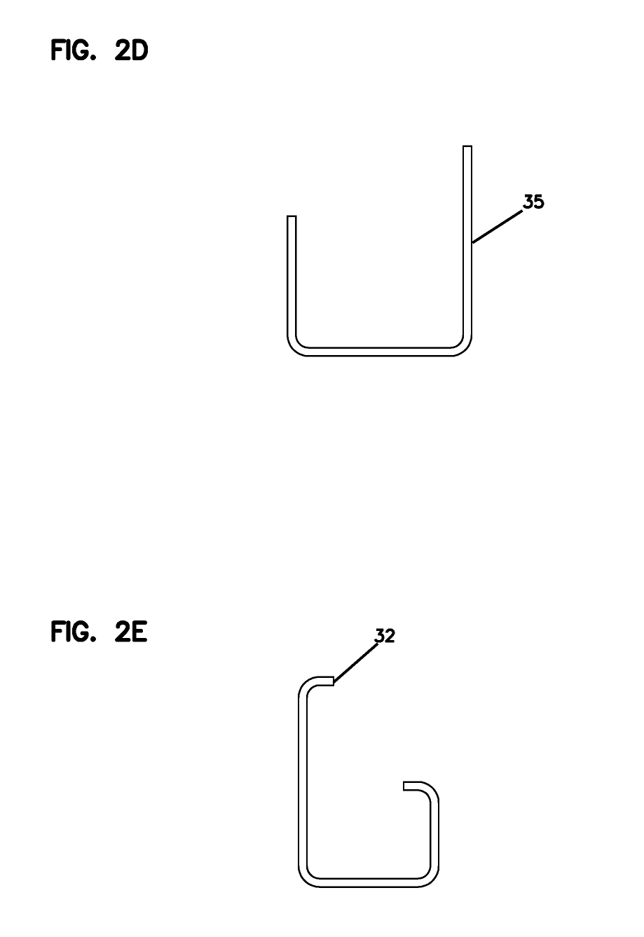

Referring now to FIGS. 2A-2E, a portion of the manufacturing process of trailer 10 is explained in more detail. FIG. 2A illustrates left side wall 18 and roof 12. Each of these two components, as well as the other main components, typically includes two main rails and multiple cross members. Roof 12 includes two main rails 36 and multiple cross members 38, and similarly left side wall 18 includes two main rails 34 and multiple cross members 32. In this embodiment, the left main rail 36 of roof 12 fits down onto the top main rail 34 of left side wall 18, via specialized features of both, as will be described in more detail below.

FIG. 2B shows the connection of the left main rail 36 of roof 12 and the top main rail 34 of left side wall 18 in more detail. FIG. 2B also shows fastener 30, for attaching a front-most cross member 32 with front wall 14. FIG. 2C shows some of this same detail in an exploded view. In this view, the left main rail 36 of roof 12 can be seen to have an inverted U-shape, to fit over the top main rail 34 of left side wall 18.

FIG. 2D is a cross-sectional view of a J-rail 35, which in some embodiments fits over the top main rails 34 of left side wall 18 and right side wall 16. J-rail 35 is configured to mate with/fit inside of the U-shaped main rail 36 of roof 12, thus providing a close fit between roof 12 and side walls 16, 18, so that the walls are very square and straight. In this embodiment, J-rail 35 has a width of about 1.313 inches, a depth of about 1.50 inches, a thickness of about 0.060 inch, and a depth of the shorter arm of J-rail 35 of about 1.00 inch. This is but one embodiment, however, and alternative embodiments of J-rail 35 may have different dimensions.

FIG. 2E is a cross-sectional view of a representative post or beam, such as cross member 32, which in some embodiments has a G-shape. As mentioned above, the G-shaped cross member 32 may have a rigidity equal to conventional cross members but with only one-third as much steel. This allows for cross members 32 that are lighter and less expensive than those typically used in conventional trailers. In this embodiment, cross member 32 has a width of about 1.50 inches, a depth of about 1.00 inch, a thickness of about 0.060 inch, and a width of the shorter arm of the G-shape of about 0.75 inch. This is but one embodiment, however, and alternative embodiments of the G-shaped post or cross member may have different dimensions.

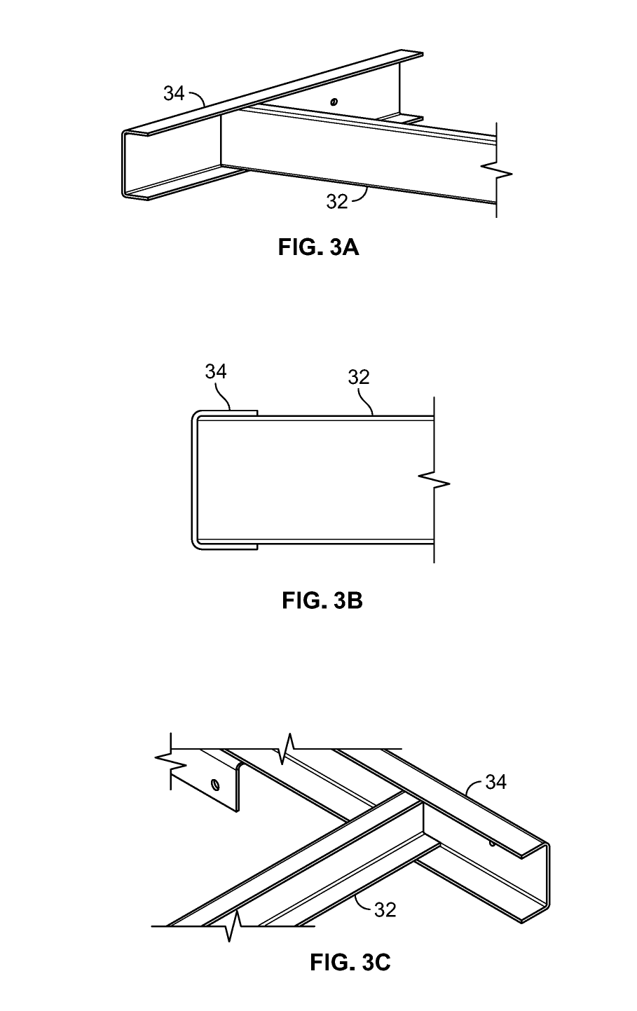

Referring now to FIGS. 3A-3C, the main rails of trailer 30 may be formed from a roll form method, with high strength steel, which allows cross members to be placed inside the open channel of each main rail. FIGS. 3A-3C illustrated one main rail 34 joined to one cross member 32, but of course any other main rails and cross members of trailer 10 may be configured and joined together in similar fashion. Proper weld placement may be used to fuse cross member 32 to main rail 34, thus forming a joint.

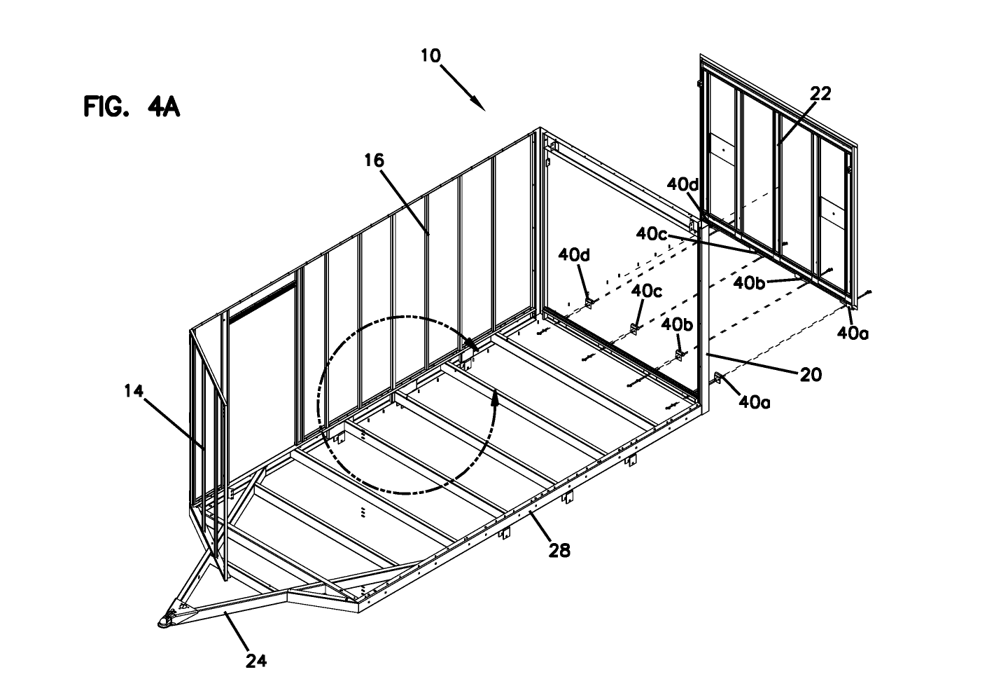

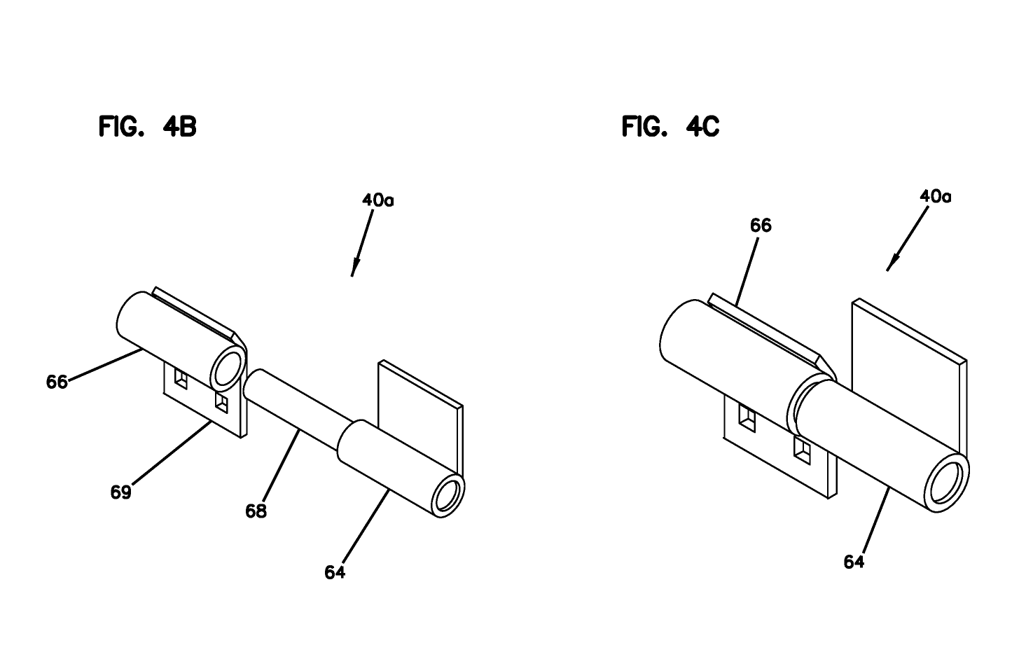

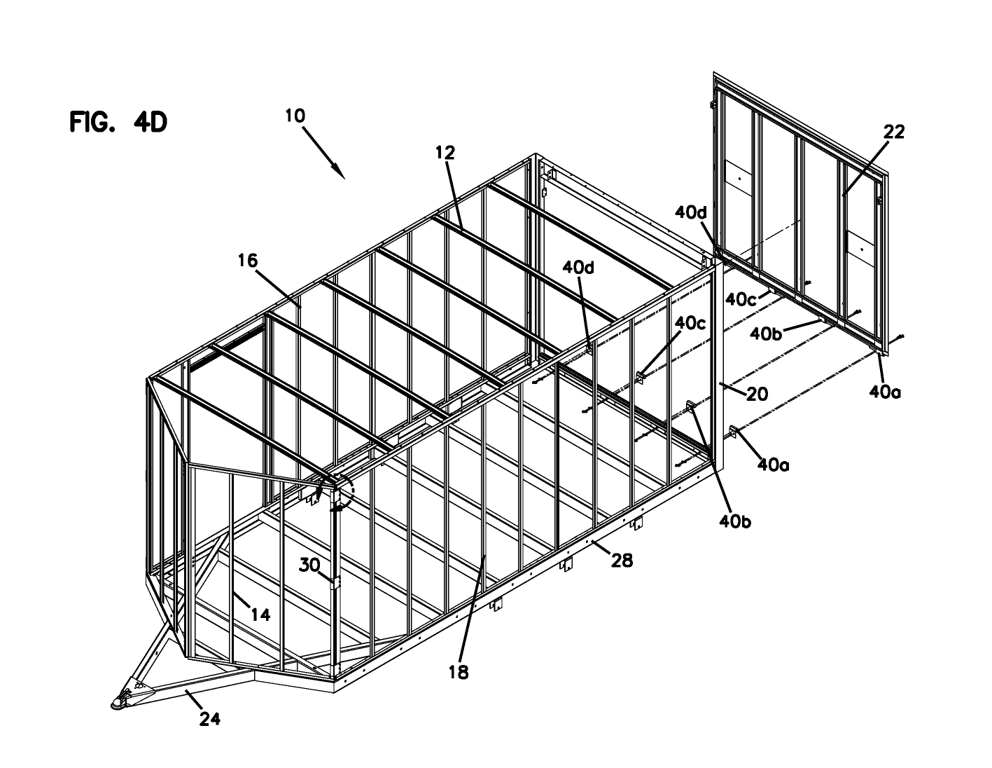

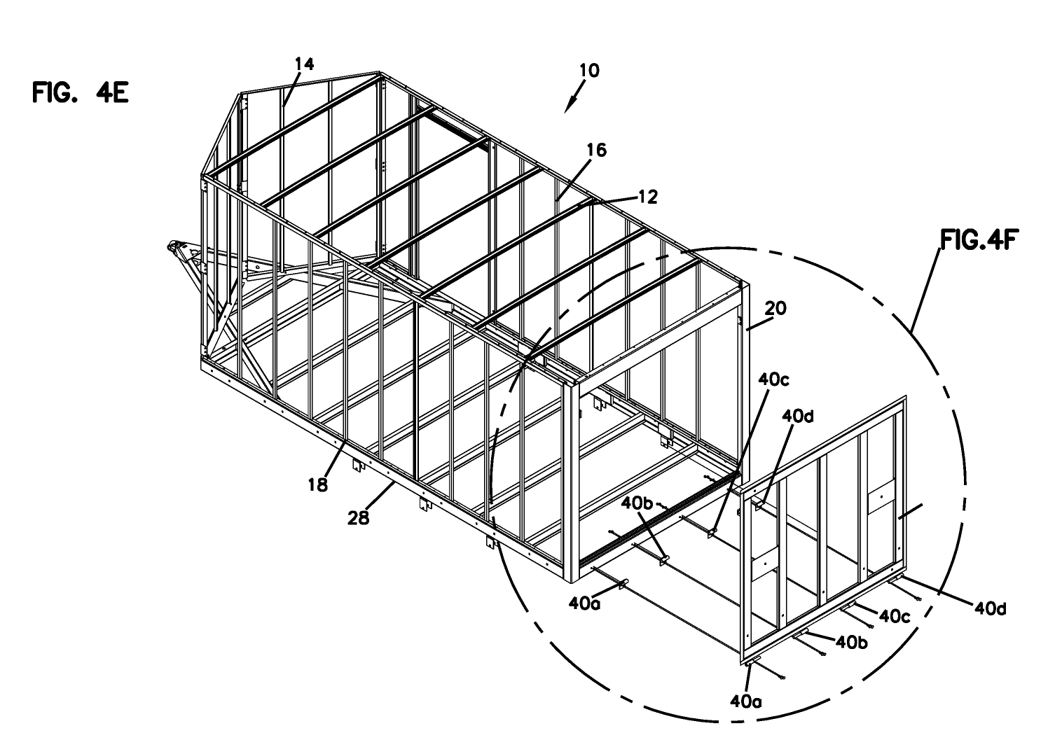

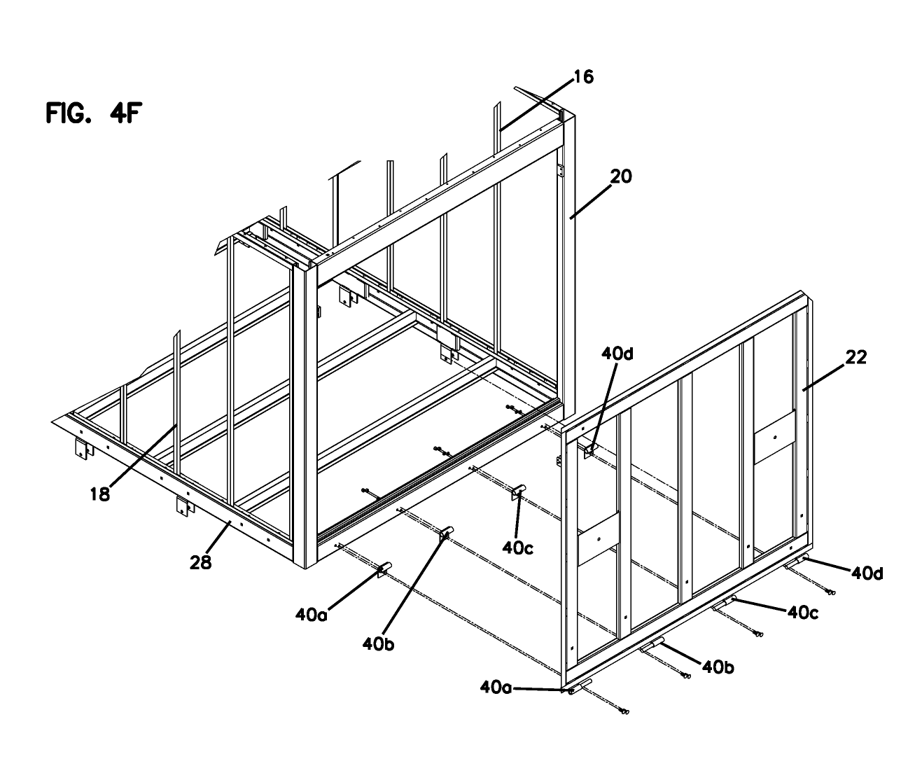

With reference now to FIGS. 4A-4F, a method for attaching rear door 22 to rear wall 20 is illustrated. In this embodiment, rear door 22 is a ramp door, but in alternative embodiments rear door 22 may instead have a barn door configuration. In the illustrated embodiment, rear door 22 is attached to rear wall 20 via multiple bolt-on hinges 40a-40d. This is in contrast to conventional trailer door hinges, which are welded onto the trailers. The use of bolt-on hinges 40a-40d, in some embodiments, facilitates swapping out rear door 22 for a different door, for example to switch to a barn-style door.

In FIG. 4A, rear door 22 is shown apart from rear wall 20, and the connection of the two parts via multiple hinges 40a-40d, each of which has multiple parts. FIG. 4D shows a similar view, but with additional components of trailer 10 in place. FIG. 4E is a rear perspective view, and FIG. 4F is a close-up view of FIG. 4E. In FIG. 4E, in is clearly seen that hinges 40a-40d include one left-sided hinge 40a, near the far left side of rear door 22, and three right-sided hinges 40b-40d, located to the right of left-sided hinge 40a. This combination of hinges, with left-sided hinge 40a located to the left, helps prevent rear door 22 from slipping out of its hinged connected with rear wall 20. It also facilitates interchangeability of rear door 22

FIGS. 4B and 4C show left-sided hinge 40a in close-up. Hinge 40a includes a male portion 64 with a dowel 68 and a female portion 60 with an opening 69 to accept the dowel. FIG. 4B shows left-sided hinge 40a in disassembled form, and FIG. 4C shows hinge 40a assembled.

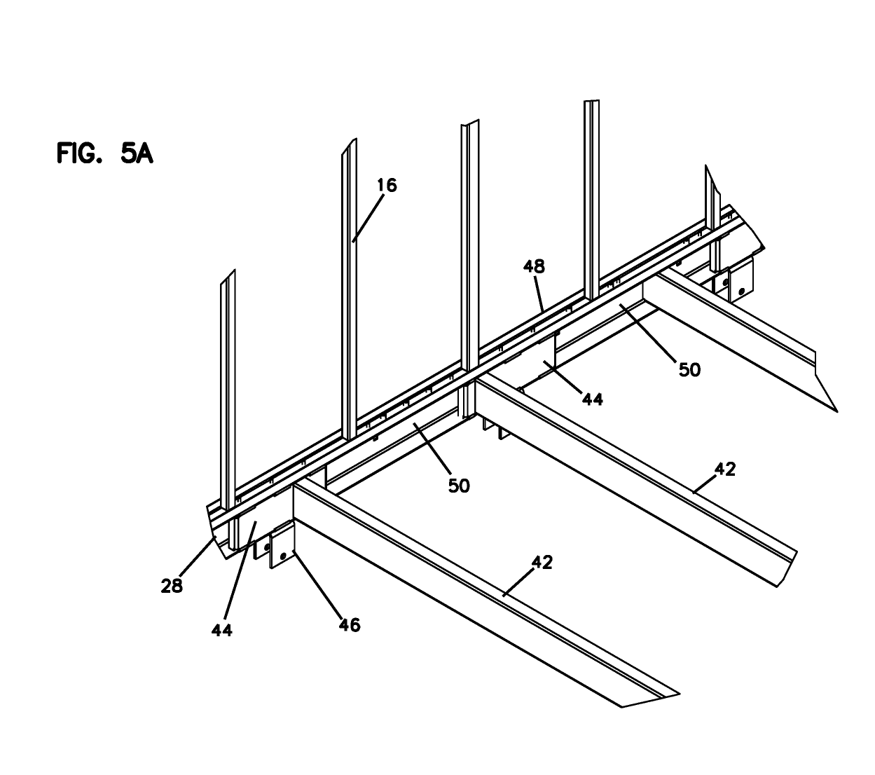

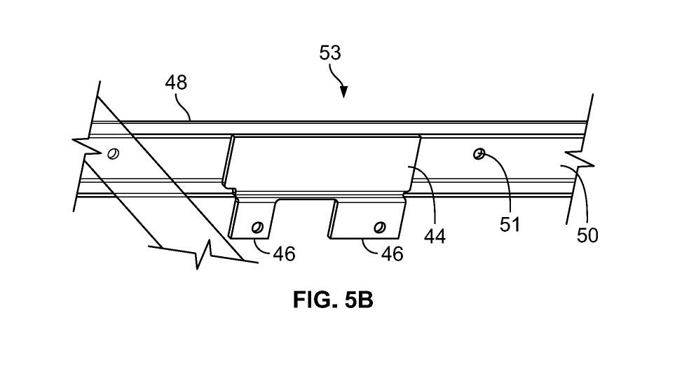

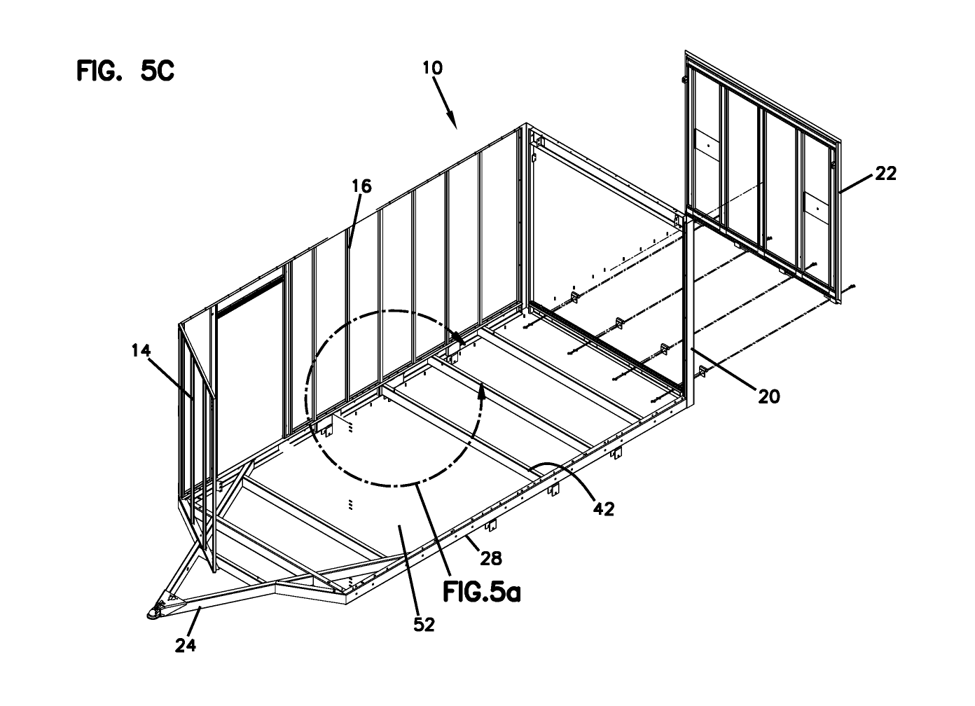

Referring now to FIGS. 5A-5C, another feature of some embodiments of trailer is an “axle bracket” attachment system 53 (FIG. 5B) for assembling floor 28. Axle brackets 53 may be positioned, for example, above the spring or tor-flex axle locations, to enhance the strength of floor 28 in certain areas, without using extra steel. FIG. 5A illustrates a portion of right side wall 16, connected to floor 28. Floor 28 includes a main rail 48 with a concave, inward facing surface 50. Some of cross members 42 are attached at their ends to brackets 44, which fit within the concave inner surface 50 of main rail 48. Other cross members 42 are attached directly to main rail 48 without brackets 44. Each bracket includes two downward projecting tabs 46. In this disclosure, main rails 48 are referred to as being part of floor 28. Alternatively, these same main rails 48 might be referred to as being part of side walls 16, 18. The nomenclature here is interchangeable, since the various parts of the main components fit together as described in either case.

FIG. 5B shows axle bracket system 53 from another perspective. Also visible here are several holes 51, which may be included in main rail 48, cross members 42 and/or other components, to facilitate paint drainage during manufacturing. FIG. 5C shows trailer 10 with several cross members 42 missing from floor 28, to illustrate how individual cross members 42 may be attached and removed from floor 28.

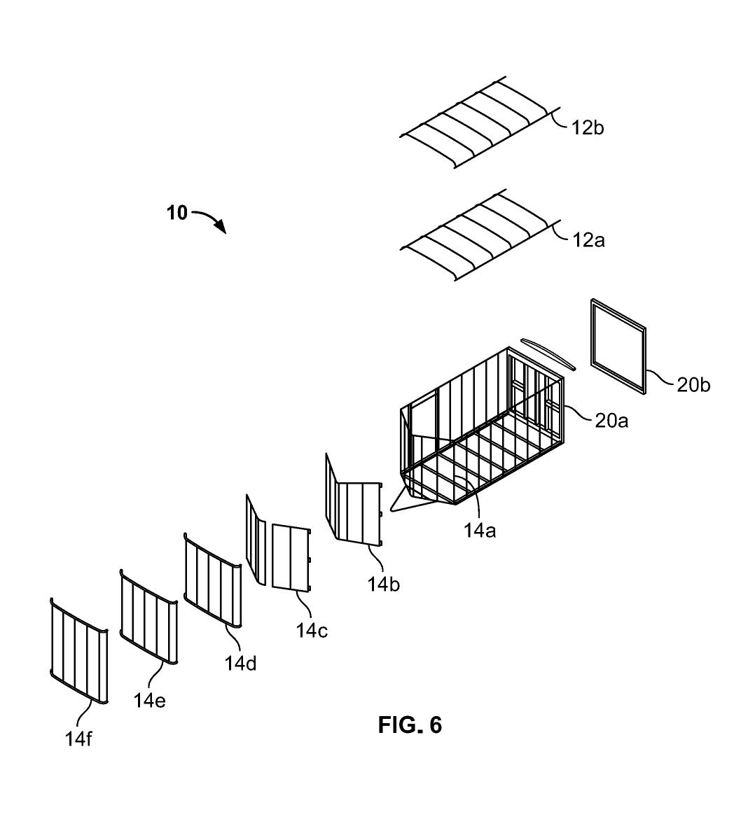

Referring now to FIG. 6, trailer 10 is illustrated with several alternative, interchangeable components, which may be swapped for other components already on trailer 10. This example illustrates the interchangeability of many, or in some cases even all, of the components of trailer 10. For example, as illustrated, multiple different shapes of front doors 14a-14f may be used with the same trailer 10. Similarly, different rear walls 20a, 20b and/or different roofs 12a, 12b may be used. These are only examples of different components that are interchangeable, and these examples should not be interpreted as limiting.

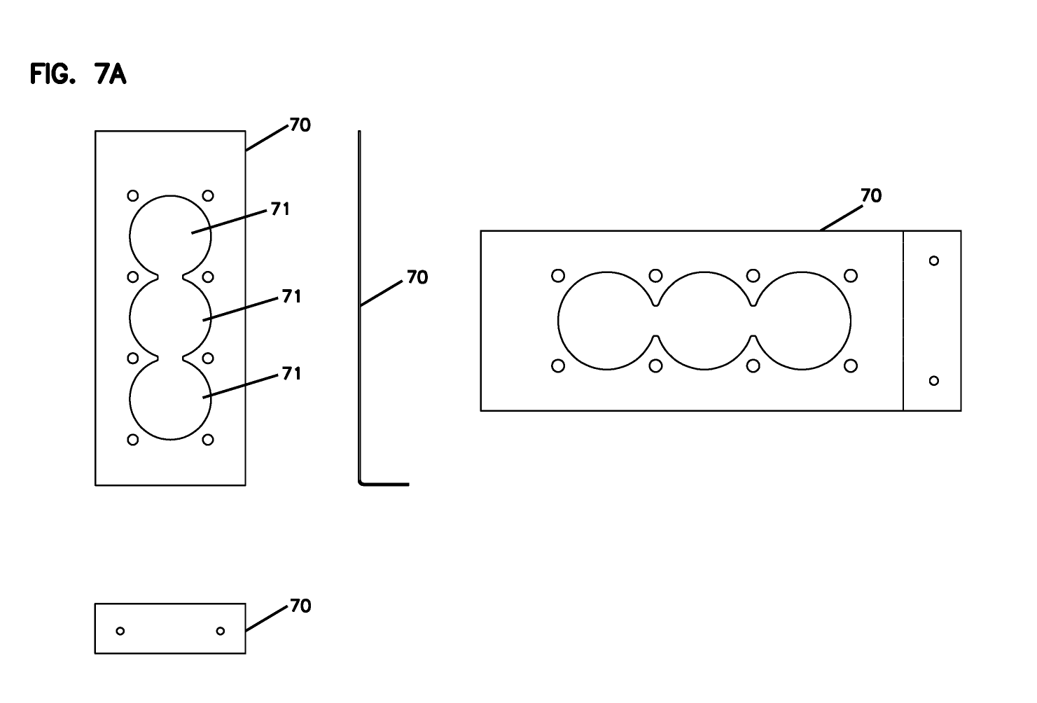

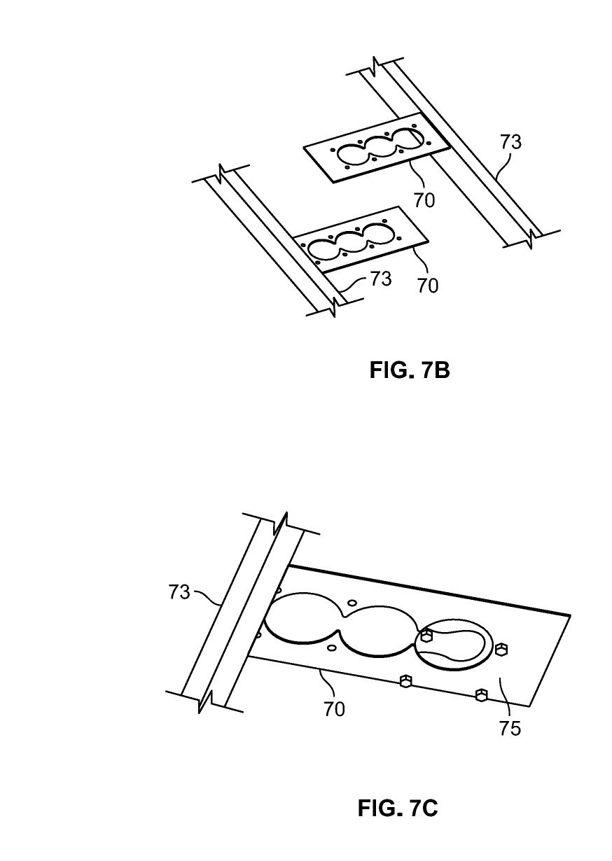

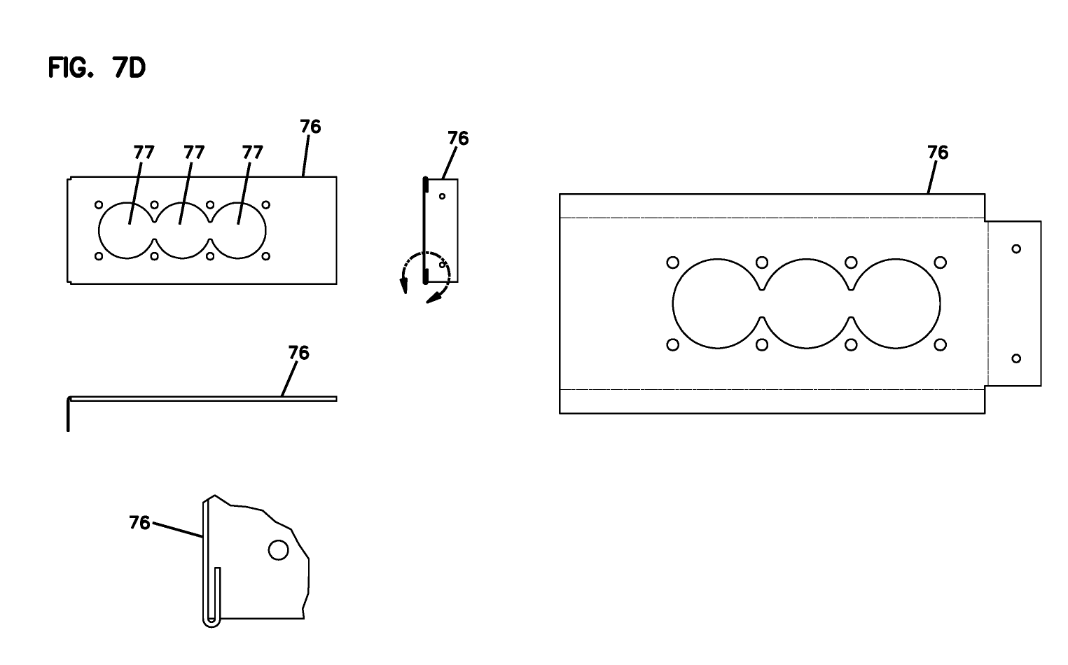

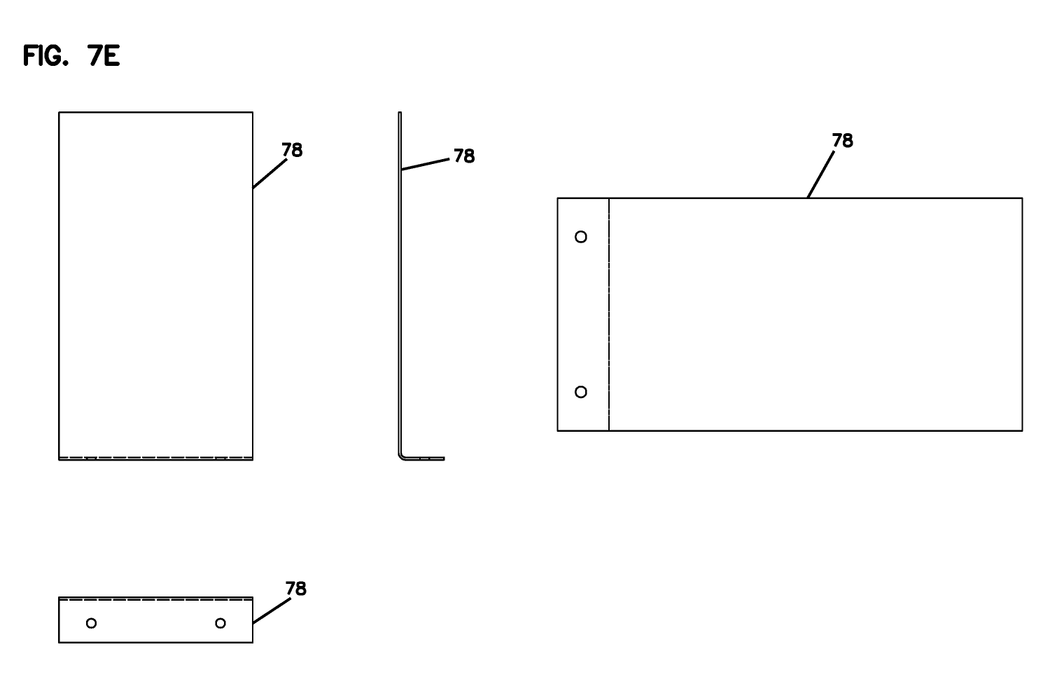

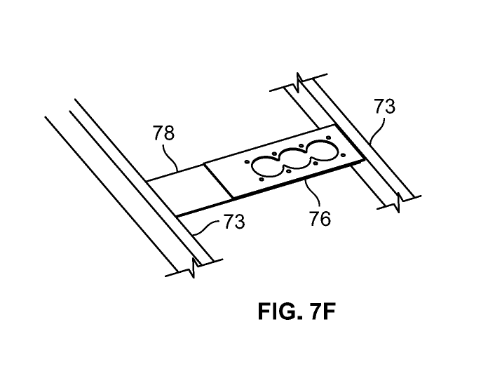

FIGS. 7A-7C illustrate a manufactured D-ring plate 70 for mounting recessed tie-down rings 75 (FIG. 7C) onto trailer 10. D-ring plate 70 allows for installation of tie-down rings after trailer 10 has been assembled. The far left and far right images in FIG. 7A are top views of D-ring plate 70, the middle image is a side view, and the bottom image is a front end view. The pattern of holes 71 on D-ring plate 70 allows for multiple mounting locations for tie-down ring 75. D-ring plate 70 may also act as a template for drilling holes for a standard 5,000-pound-capacity tie-down ring. In some embodiments, D-ring plates 70 are attached to trailer 10 with mechanical fasteners and without welding. As illustrated in FIG. 7B, D-ring plates 70 may be mounted to either the front or the back of a cross member 73 of trailer 10.

FIGS. 7D-7F illustrate an alternative embodiment of a D-ring plate 76. This embodiment of D-ring plate 76, illustrated in FIG. 7D, may be used in the same, single-sided fashion as the previously described embodiment of D-ring plate 70, or alternatively it may be used with a support member 78 (FIG. 7E). As illustrated in FIG. 7F, support member 78 is attached to one cross member 73, D-ring plate 76 is attached to an opposite cross member 73, and the free end of support member 78 fits into an opening on the free end of D-ring plate 76. Support member 78 thus provides support to D-ring member 76, so that the tie-down ring (not illustrated in FIG. 7F) is supported from both cross members 73. In some embodiments, support member 78 may slide into the free end of D-ring member 76, so that support member 78 can be adjusted for different cross member spacing options.

D-ring plates 70, 76 are only one type of fastener that may be used with a given embodiment of trailer 10. The components of trailer 10 may be assembled with mechanical fasteners of many various types. For example, features of the components may allow flanges to be mated and locked to each other through metal forming methods already available or through a created hole with structural rivets. One other fastener 30 has been shown in prior figures. Other fasteners include Huck fasteners, which may be used with a TOX 8 mm and 12 mm assembly method. These are only examples, however. Any suitable fasteners may be used to assemble trailer 10, and in many embodiments the various fasteners greatly facilitate interchangeability of the components.

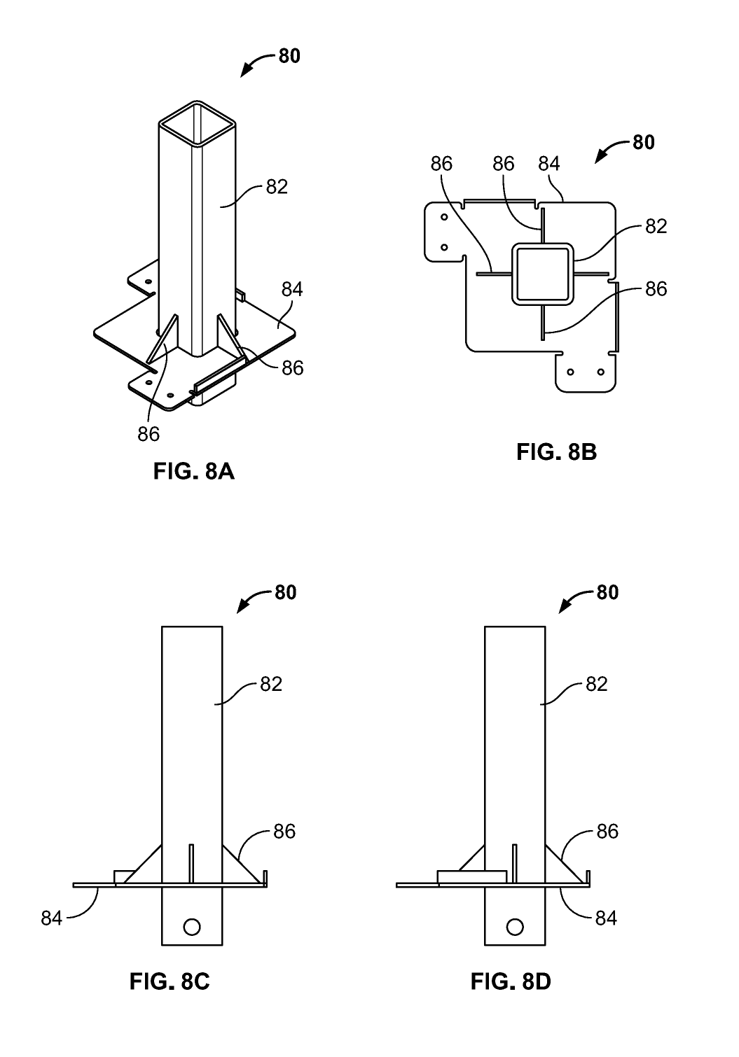

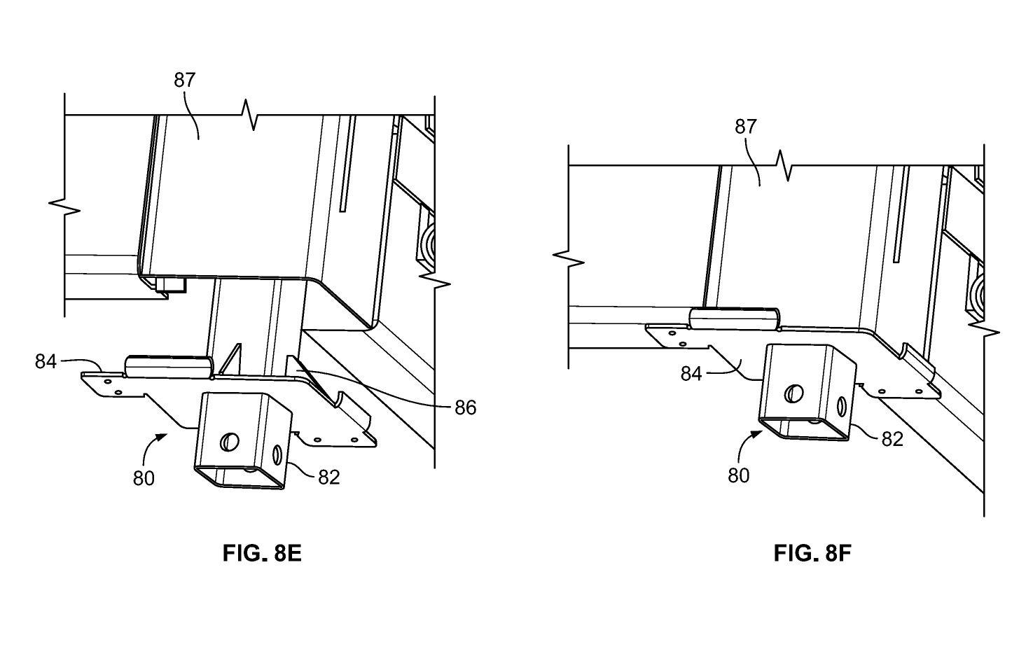

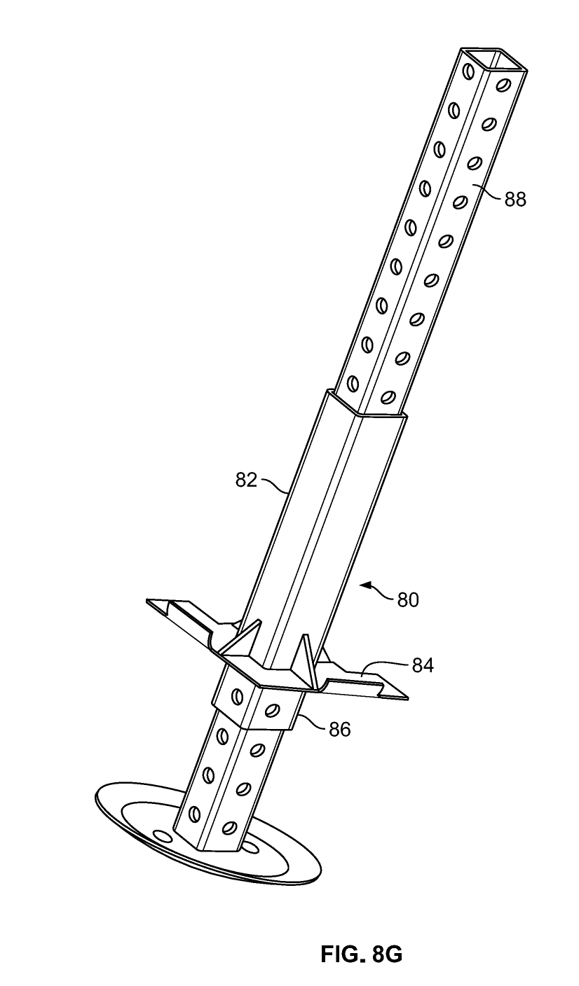

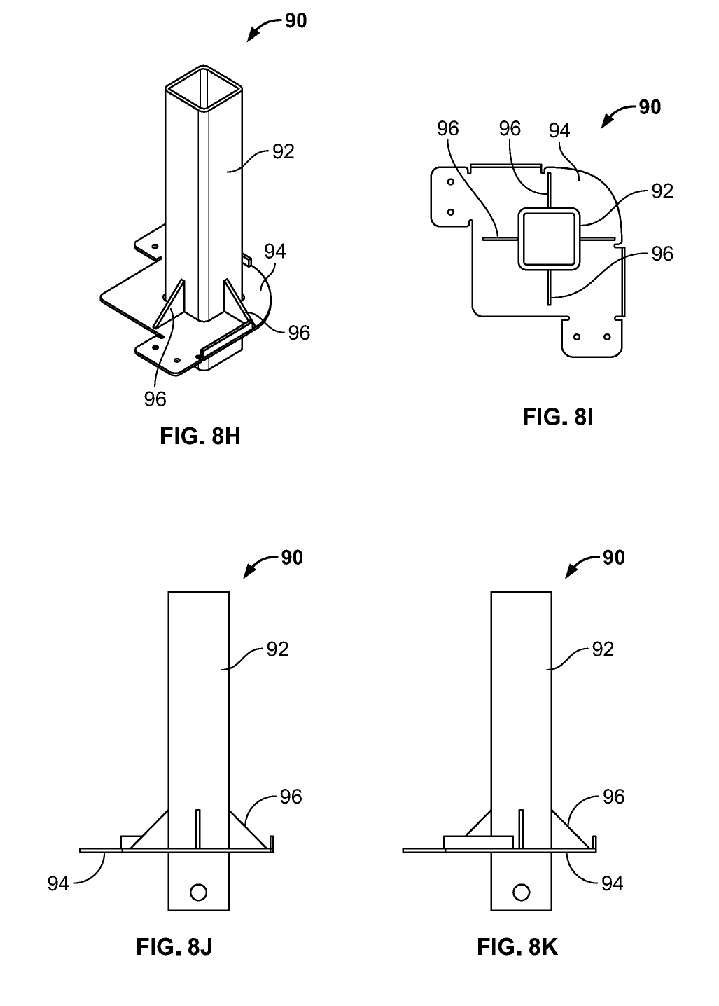

FIGS. 8A-8G illustrate one embodiment of a weldment 80 for a drop down stabilizer jack 88 for trailer 10. Weldment 80 includes a tube 82 (or “post”), a plate 84 and multiple gussets 86 extending between tube 82 and plate 84. FIGS. 8A-8D are perspective, top, and two side views, respectively, of weldment 80. FIGS. 8E and 8F show weldment 80 being inserted into a corner post 87 of trailer 10. FIG. 8G shows drop down jack 88 inserted into weldment 80. Weldment 80 allows for the mechanical fastening of drop down jack 88 to trailer 10 without additional welding. Weldment 80 is inserted into corner post 87 and attached mechanically from the bottom. On older, conventional trailers, drop down jacks cannot typically be added after the trailer is constructed, because doing so would require modification of the trailer frame. Weldment 80 in the current embodiment, by contrast, does not disturb the existing paint or frame of trailer 10. The same weldment 80 works for both the roadside and curbside of trailer 10, according to some embodiments. Once weldment 80 has been mechanically fastened, drop down jack 88 can be inserted. It may be assembled after trailer 10 is complete or during the manufacture of trailer 10. One drop jack 88 may be housed in each of the four corner posts 87 of trailer 10 or only in some of them.

Weldment 80, of FIGS. 8A-8G, is designed for a square corner post 87 of trailer 10. FIGS. 8H-8K illustrate an alternative embodiment of weldment 90, which also includes a tube 92, a plate 94 and gussets 96. In this embodiment, plate 94 is designed for a trailer with a round corner post and thus includes one rounded corner. Weldment 80 or 90 may have other shapes and sizes in alternative embodiments.

Although the preceding is believed to be a complete and accurate description of various embodiments and features of a modular trailer and manufacturing method therefore, the descriptions are of embodiments only and are meant to be exemplary in nature. Any number of variations, additions and alterations may be made to any given embodiment, without departing from the scope of this disclosure. Therefore, the description of any one embodiment should not be interpreted as limiting the scope of the invention.

What is claimed is:

1. A modular trailer, comprising:
a floor component;
two side wall components;
a front wall component;
a rear wall component;
a rear door component; and
a roof component;
wherein at least some of the components are interchangeable, such that they are attached to one another via fasteners that allow any one of the interchangeable components to be removed from the modular trailer without disassembling the modular trailer.

2. The modular trailer of claim 1, wherein the components are provided in an unassembled kit to be assembled by a user.

3. The modular trailer of claim 1, wherein each of the components comprises:
two main rails; and
multiple cross members coupled to and extending between the two main rails.

4. The modular trailer of claim 3, wherein the main rails of the floor component comprise 50 HSLA steel, and wherein all the other main rails and cross members comprise 36 structural steel.

5. The modular trailer of claim 3, wherein the multiple cross members are robotically welded to the two main rails.

6. The modular trailer of claim 1, wherein the roof component is attached to the front wall component, the rear wall component, and the two side wall components via a keyed fastening mechanism.

7. The modular trailer of claim 6, wherein the keyed fastening mechanism comprises:
a J-rail on a top of each of the front wall component, the rear wall component and the two side wall component; and
a U-shaped fixture on the roof component that fits over the J-rail.

8. The modular trailer of claim 1, wherein the front wall component attaches to the side wall components via tab fasteners.

9. The modular trailer of claim 1, wherein the rear wall component comprises a flange surface with a turned edge.

10. The modular trailer of claim 1, wherein the rear door component is attached to the rear wall component via one left-sided hinge and multiple right-sided hinges.

11. The modular trailer of claim 1, wherein the rear door component is attached to the rear wall component via one right-sided hinge and multiple left-sided hinges.

12. The modular trailer of claim 1, wherein the rear door component comprises a single-sided ramp door.

13. The modular trailer of claim 12, wherein the rear door component is changeable to a double, barn door configuration.

14. The modular trailer of claim 1, further comprising at least one D-ring plate attached to the trailer for attaching a tie-down ring to the trailer.

15. The modular trailer of claim 1, further comprising at least one drop-down jack weldment attached to a corner post of the trailer via a mechanical fastener without welding.

16. A method for manufacturing a modular trailer, the method comprising:
assembling multiple components, comprising a floor component, two side wall components, a front wall component, a rear wall component, a rear door component, and a roof component,
wherein assembling each component comprises connecting multiple cross members across two main rails, and
wherein at least some of the components are interchangeable, such that they are attached to one another via fasteners that allow any one of the components to be removed from the modular trailer without disassembling the modular trailer.

17. The method of claim 16, further comprising:
forming the cross members to have a shape selected from the group consisting of a U-shape and a G-shape; and
forming the roof component to include a self-locating U-shaped fixture that fits over corresponding J-shaped fixtures on the tops of the wall components.

18. The method of claim 16, wherein assembling each of the components comprises:
placing ends of the cross members into open channels of the main rails; and
welding the cross members to the main rails to form joints, wherein at least the welding step is performed by a robot.

19. The method of claim 16, wherein assembling the floor component comprises attaching at least some cross members of the floor component to axle brackets attached to two main rails of the floor component.

20. The method of claim 16, further comprising:
shipping the modular trailer in an unassembled kit configuration to a user;
attaching a wall panel member of each component to a frame of each component, wherein the wall panel member for each component is no more than one inch thick;
removing one of the components from the modular trailer;
replacing the removed component with a replacement component having at least one of a different size or a different shape, without disassembling the rest of the modular trailer;
attaching at least one D-ring plate to the trailer, for attaching a tie-down ring to the trailer;
attaching a drop-down jack weldment to the trailer using mechanical fasteners, without welding; and
inserting a drop-down jack into the drop-down jack weldment.
